(19) United States
(12) Patent Application Publication
(10) Pub. No.: US 2002/0161628 A1
(43) Pub. Date: Oct. 31, 2002

(54) Voter feedback and receipt system

(76) Inventors: C. Lane Poor, JR., Warren, RI (US); David D.S. Poor, Meadowbrook, PA (US)

Correspondence Address: John J. Marshall, Drinker Biddle & Reath LLP, One Logan Square, 18th & Cherry Streets, Philadelphia, PA, 19103-6996, US

(21) Appl. No.: 09/843,335

(22) Filed: Apr. 26, 2001

(51) Int. Cl. G06F 17/60

(52) U.S. Cl. 705/12

(57) ABSTRACT

Methods and apparatus are shown that provide an improved system for recording intended votes in elections. The system includes the voter verifying the interpretation of a voter's ballot by a ballot counting device, an electronic recording of the voter's intended votes on the ballot for possible recounting, and providing a printed receipt of the votes case by the voter. In the preferred embodiment of the invention, voters record their vote by making marks on paper ballots, which are interpreted by reading device. Alternative implementations are provided using mechanical voting, optical reading, or electronic voting devices including interactive systems such as would be used on the Internet. A recording and receipt device presents the interpreted vote for verification by the voter before recording the choices. This creates a less ambiguous record of the choices. The recording and receipt then present the voter with a receipt showing the votes recorded. The voter can choose to have the verification interpreted in a choice of languages or modalities.

### BACKGROUND OF THE INVENTION

1. Field of the Invention

This invention is related to the field of mechanical voting machines.

2. Description of Related Prior Art

The controversy over ballot counting in the 2000 United States Presidential Election has shown inherent weaknesses of several apparatus and methods currently used to record and tally votes. The goal of an election process is to accurately record votes as intended by the voter, but there are sources of error that lead to non-counting and miscounting votes. According to at least one news source, over two percent of the votes cast in a national political election are not counted in the manner intended by the voter regardless of voting apparatus and methods.

Voting Systems to Process Paper Ballots:

Traditionally, votes were cast on paper ballots. Paper ballots were originally counted by hand: a process that is slow, expensive, prone to random error and susceptible to intentional distortion or fraud.

In order to speed up the counting process, reduce costs, and increase reliability, mechanical systems have been developed to process paper ballots. Some are based on reading pencil or pen marks, while others are based on recognizing holes punched in the ballots. For all such recording devices, there is a certain range of voter responses that will be on the cusp between being recognized as an intended vote and or not. Ballots with responses within that range may sometimes be interpreted as intended votes and sometimes not. Such differences can easily appear from one mechanical device to another, but can also appear within multiple processing by the same device, when counted by two different people, or even when counted by the same person twice. It is often difficult or impossible to determine the intent of the voter based on examining the paper after the voter has completed voting and the voter's intent is either not recognized or is not tallied properly.

Mechanical and Electronic Voting Systems:

While many ingenious schemes have been developed to reduce the errors in recording and tallying votes from paper ballots, errors still occur. Such alternative systems include mechanical voting machines and electronic systems, all of which are more expensive than paper-based systems. As a result, less affluent areas tend to have disproportionally high error rates resulting in an increased likelihood of disenfranchisement correlated to income. Some electronic systems use computer screens to display choices and a stylus or light pen to register choices. Newer electronic voting systems employ touch screens or similar devices for voters to use in registering their votes.

“WEB” Based Voting Systems:

New voting systems are being developed to take advantage of the rapidly expanding capabilities of the Internet. Some Internet based implementations propose systems based an official polling site to ensure voter eligibility, while others will extend voting access to any internet-accessible computer system.

Confirmation of Electronic Transactions:

With most interactive systems requiring electronic business transactions, the user is typically asked to verify his or her entries before they are posted. This confirmation is experienced by the public in such applications as Automatic Teller Machines (ATMs) and has been adopted in systems using computer entry of vote selections. A special confirmation screen may be shown following each entry to ensure that the proper choice was selected. Confirmation of the whole set of choices selected does exist in several web-based systems including VoteHere by Votehere, Inc. and vballot™ from Validity systems, Inc.

While the practice of verifying computer-based entries has been well established in the financial markets and has been adopted to computer-based entries in voting, this concept has been lacking in more traditional voting methods including paper ballots, mechanical voting machines, and electronic voting machines (such as touch-screen devices).

Recording Votes as the Voter Intends:

Whether paper-based, mechanical, or electronic, all systems can misinterpret voters' intentions, yielding inaccurate vote counts. Voter confusion or mistakes can account for some errors, especially with unfamiliar electronic voting systems. With paper ballots, there is added inconsistency in the mechanical processing; the same set of ballots processed on the same machine multiple times will often yield slightly different results. The 2000 Presidential Election recount effort in Florida has further shown that even well-intentioned election personnel can not consistently be counted on to resolve ambiguous or improperly completed ballots.

### SUMMARY OF THE INVENTION

The invention provides a voter feedback mechanism to allow the voter to verify the interpretation of his or her ballot and then be provided with a receipt showing how his votes were tallied. Votes are counted only after the system's interpretation of the votes has been verified by the voter and the voter is given a positive record of the votes that have been counted.

The invention seeks to reduce the errors in recording and tallying votes by providing feedback to the voter with the opportunity to correct or replace the ballot if the voter's intent is not properly recognized. The system relies on the voter to verify that the votes to be tallied correspond to his intentions.

The invention also seeks to reduce possible uncertainty in recounts by providing an unambiguous record of the verified votes cast by the voter.

Finally, the invention provides the voter with an unambiguous printed receipt showing all of the votes recorded on his behalf. The use of such a receipt can reduce mistrust in the voting apparatus and systems used.

The implementation of the systems described herein has the potential to ensure that votes are counted accurately and reflect the wishes of the voter, and to reestablish voter confidence in the voting process. While the primary implementation of this invention is be with paper ballots marked by pencil or pen, it can also be used with other recording devices, including the “punched card” systems, electronic “touch pad” devices, and other electronic voting systems. As a result, this invention can be used without the expense of totally replacing these systems.

### BRIEF DESCRIPTION OF THE DRAWINGS

FIG. 1 shows the flow of a ballot in an apparatus and method according to the invention.

FIG. 2 shows a floor plan suitable for voting using a single device for recording and receipt according to the invention.

FIG. 3 shows a block diagram of a recording and receipt device according to the invention.

FIG. 4 shows a simple implementation of the invention using two pieces of standard computer equipment and a metal ballot box.

FIG. 5 shows a series of ballots suitable for optical processing.

### DETAILED DESCRIPTION OF PREFERRED EMBODIMENTS

Using Paper Ballots:

In the preferred embodiment, the ballots are inexpensive paper ballots on which voters record their choices by marking a ballot. This is referred to as a “marked paper ballot” process. An optical reading device is used to “read” the marks on the paper, a process commonly called “Optical Mark Reading”. This can include a system specifically designed to process marked paper ballots such as described by Keane, et al. (U.S. Pat. No. 4,760,247) or a more general utility optical system.

Ballot Control:

In addition to detecting the apparent votes cast on the ballot, the optical reading device may be part of a ballot control process to ensure that only valid ballots are counted. This function may include processing machine-readable indicia printed on the ballot, such as indicia identifying the elections on the ballot and/or a unique identifier for the particular ballot. Election officials can set the recording and receipt device to accept one ballot as each voter enters the area containing the device. Other ballot controls can be added to the system to ensure that only valid ballots are processed and counted.

Recording and Receipt Device:

The voter completes his ballot and then waits for the recording and receipt device to become available. The voter then places the ballot into the recording and receipt device. The device first interprets the apparent votes and then presents the votes to the voter for approval. After approval, the device records the votes and writes an unambiguous record of the votes on the ballot, and produces a receipt of the votes recorded for the voter.

Since the device is used for one ballot at a time, and since the voter can indicate when his votes are not properly interpreted, the responsibility for accurately interpreting a poorly completed ballot is shifted to the voter, not the machine. This invention relies on the diligence of the voter to ensure that there have been no failures, and that the votes cast properly reflect the intent of the voter.

Verifying the Votes Cast:

In the preferred implementation, based on the marks made by the voter on the ballot and detected by the optical reading device, the recording and receipt device interprets marks as intended votes for specific candidates.

The system then provides a list of votes to be tallied to the voter. This can be in the form of a printed report, a display on a computer display, through an audio (verbal) message, through a braille touch-pad, or other appropriate means. By default, the preferred embodiment of the invention uses a computer display for which the voter gets to select the language. For illiterate voters, visually impaired voters, and others for whom such a display would be inappropriate, the voter may select auditory or other means of delivery.

The voter examines the list of votes to be recorded and tallied. If the list is not in exact compliance with the intentions of the voter, he can indicate “reject” and the ballot is returned for correction or replacement. If the list is in compliance, he can indicate “accept” and the ballot is recorded and tallied.

Recording of Verified Votes:

Two methods are used to ensure that the “accepted” set of votes are recorded and tallied. First, the recording and receipt device immediately records the votes and includes them in running tallies. Second, an unambiguous electronic representation of the votes is recorded on the ballot for future recounts, if needed. The electronic representation of the votes removes from question any question of interpretation since the electronic representation is unambiguous and verified by the voter.

The electronic representation is then available for use in any subsequent recount, verification, or other post-election day processing to provide an accurate record. The unambiguous electronic representation ensures that the voter's intentions are properly reflected each time the ballot is examined or processed. This unambiguous electronic representation may be printed on the paper ballot in the form of a barcode.

To ensure the accuracy of the unambiguous representation, the recording and receipt device should also “read” the representation in order to ensure (a) that the representation is successfully recorded, and (b) that the representation recorded the correct information. In the preferred implementation the recording is done with a barcode containing an internal check-digit, and the barcode is read immediately after being written to ensure that all systems are working properly.

Voter Receipt:

This invention provides a printed receipt to the voter. Once the voter has indicated acceptance, the recording and receipt device is used to ensure that the voter has a printed report showing the votes processed on his behalf. This establishes and maintains voter confidence in the voting system, provides reassurance to the voter that his votes were properly processed, and gives the voter a means to subsequently check exactly for whom he had case a vote. When the voter indicates acceptance based on a printed report of votes to be processed, that report may serve as the receipt.

Reducing Sources of Errors:

The system overcomes errors that can prevent a voter's intentions from being properly reflected in the recording and tallying of the votes, such as

1. Voters can erroneously vote for the incorrect candidate or choice;

2. Voters can enter a vote for the desired candidate or choice but fail to make their vote in the prescribed manner;

3. Ballots can be damaged or made unprocessable between the time the voter recorded the votes and the time the ballot was recorded;

4. Mechanical or software malfunctions or systemic errors may cause a recording or tallying system to fail to record a vote that was properly cast; and

5. Mechanical or software malfunctions or systemic errors may cause votes to improperly recorded.

The invention accounts for all of the above sources of error. When voters erroneously vote for an unintended candidate or choice, the invention shows them the consequences of their action and offers the voter the opportunity to correct the error by rejecting the apparent votes. When voters enter a vote for the desired candidate or choice but fail to make their vote in the manner proscribed, the invention shows them the consequences of their action and offers the voter the opportunity to correct the error by rejecting the apparent votes. Ballots that were damaged or made unprocessable between the time the voter recorded the votes and the time the ballot was recorded are detected by the recording and receipt device, which offers the voter the opportunity to reject the apparent votes. Although mechanical or software malfunctions or systemic errors may cause a recording or tallying system to fail to record a vote that was properly cast, the invention shows each voter the results of the ballot as processed and offers the voter the opportunity to reject the apparent votes. In addition to all of the above, even when a ballot is properly recorded and tallied, the vote may not be included in the final tallies because of errors in transmitting the vote tally. In traditional processing, these errors can occur when a single ballot is torn or damaged, or with multiple ballots when a ballot box is omitted from overall tallies. These errors may be caused by system errors or random errors (normally human error). Because of the unambiguous recording of verified votes on the ballot, this invention provides a method to accurately recreate the votes that the voter intended to cast by utilizing the unambiguous record of verified votes.

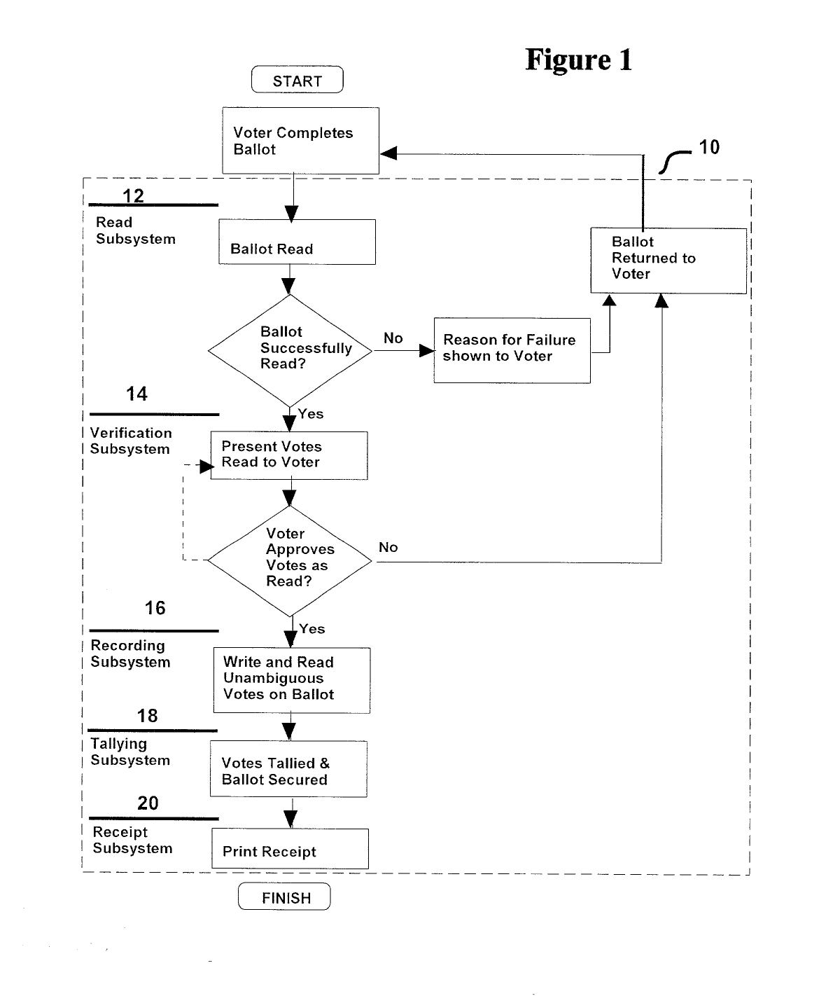

Referring now to the drawings, FIG. 1 shows the flow of a ballot under control of a Recording and Receipt device 10.

The voter completes the ballot by making appropriate marks on a paper ballot. The voter or an election official then places the ballot into the Recording and Receipt device at Read Subsystem 12, which may be an inexpensive scanning device such as commonly used in facsimile machines or other optical scanning devices. The Read Subsystem detects marks, such as by OMR, from the image captured by the scanning device. If the system is unable to detect marks properly, such as when the ballot is ripped, upside-down, or folded, the voter will be shown the reason that the ballot could not be read, and the ballot will be ejected from the Recording and Receipt device 10 and returned to the voter or official for corrective action.

If the votes have been apparently successfully read by the Read Subsystem 12, a Verification Subsystem 14 will present the set of votes to the voter. This presentation is preferably on a computer screen and will default to the display of the votes in the predominant language. When multiple language ballots are used, the default language may be selected to match the language of the marked ballot. The voter may have the option to select a suitable language and an alternative presentation modality including display on a computer screen, printed on paper, printed on paper in large print, or auditory (using headphones). The voter may have the option to have the same presentation multiple times (such as for auditory presentation) or to choose a different presentation (shown by the dashed selection line between steps 5 and 4 in FIG. 1).

In all implementations, the voter will then be given the opportunity to accept or reject the votes as presented. This choice normally may be indicated by a “double confirmation” by twice pressing an “accept” button on the Recording and Receipt device, with an appropriate message being displayed between the two pressing of the button such as “Are you SURE you want to confirm these votes?”. If the voter presses the corresponding “reject” button at any time, the Verification subsystem will eject the ballot so that the voter can change or clarify his or her votes.

The Recording and Receipt device includes a Recording Subsystem 16 to create and verify a record of the votes on the ballot before the votes are submitted for tallying. This subsystem may consist of a barcode printer and a barcode reader. The barcode printer first prints, on the paper ballot, a barcode containing a record of all votes cast. The barcode reader then reads the printed barcode to make sure that the barcode was successfully printed. If the barcode reader cannot properly read the barcode, election officials can take corrective action such as replenishing the ink in the barcode printer or cleaning the barcode reader, and reprocessing that stage of the process.

Once the Recording Subsystem 16 has successfully recorded and verified the unambiguous record of the votes, a Tallying Subsystem 18 will accept the votes as final and complete the ballot processing. In the preferred embodiment of the invention, this step includes adding the votes to a running tally within the device. The paper ballots will then be placed within a “ballot box” for safe keeping. At the same time, Receipt Subsystem 20 may print a final receipt of all votes cast on the ballot and present the receipt to the voter.

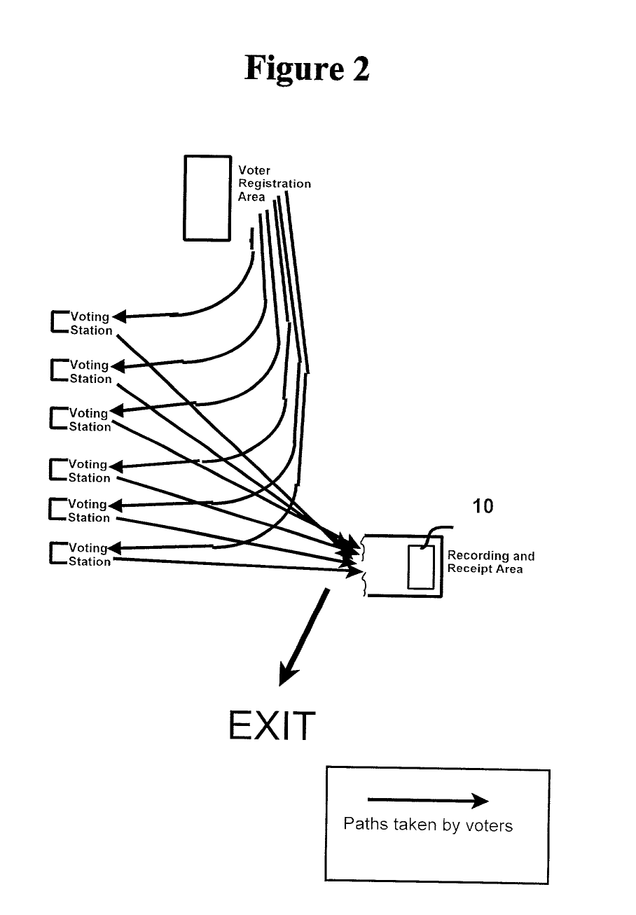

FIG. 2 shows a floor plan of a site suitable for voting using a single Recording and Receipt Device 10. Once the voters have been deemed eligible to vote and given ballots, they mark their ballots in individual stations. Once the voter has completed the ballot, she takes the ballot to a recording and receipt area containing the Recording and Receipt device. This area may be equipped with full curtain privacy for the voter. Because the voter marks his or her ballots prior using the Recording and Receipt device, a single Recording and Receipt device 10 can meet the load of several voting machines.

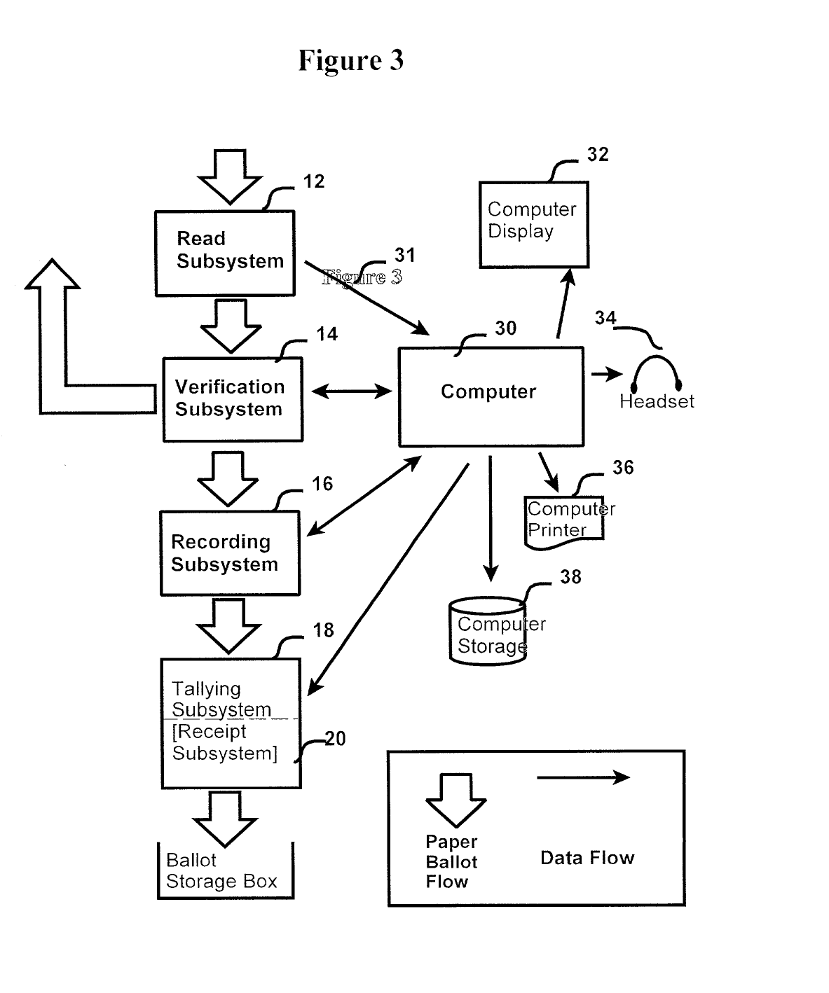

FIG. 3 shows a block diagram of a Recording and Receipt device 10. The flow of the ballots is shown by large arrows. The first subsystem is the Read Subsystem 12, which may include a scanning mechanism capable of (a) accepting the ballot, (b) capturing a digitized image of the ballot including, at least, the areas in which the voter indicates his or her choices, and (c) transferring the digitized image to a computer 30. The flow of the digitized image to the computer is shown by a data path arrow 31. Once the digitized image is stored in the computer, the marks made by the voter are processed and converted into “apparent votes” by the computer. While the preferred embodiment of this invention utilizes the computer to interpret the marks and identify apparent intended votes, other techniques can be used to achieve this portion of the process.

Once the apparent votes are determined, the computer 30 is used to present the set of votes to the voter. FIG. 3 shows three methods by which voters can be shown the apparent votes. The presentation can be a visual presentation using a computer display 32, an auditory presentation using a headset 34, or a visual presentation using printed output from a computer printer 36. Other methods and apparatus can be used including braille devices.

Based on the presentation, the voter will indicate acceptance or rejection of the apparent votes. The voter may make the selection by pressing one of two large buttons (not depicted) located anywhere on the Recording and Receipt device that serve as input devices for the computer 30. The voter's decision will be acted upon by the Verification Subsystem 14, which consists of a mechanism capable of transferring the ballot from the Read Subsystem 12 to one of two destinations. If the voter indicates rejection, the Verification Subsystem 14 will re-route the ballot back to the voter as shown in the ballot path.

If the voter indicates acceptance, the Verification Subsystem 14 will route the ballot to the Recording Subsystem 16. The Recording Subsystem 16 is capable of first printing on the ballot an unambiguous record of the votes as read by the Read Subsystem 12 and subsequently reading that printed record to ensure that the record was properly printed. The recording is done using barcode, and the printing mechanism may be an inkjet printer. Although the functions of the Recording Subsystem 16 could be done with a stationary ballot having first the printing mechanism, and then a reading mechanism passed over the same area within the ballot, in the preferred embodiment, the Recording System transports the ballot through both the printing mechanism and then the read mechanism.

In the preferred embodiment of the invention, the functions of the Recording Subsystem 16 are controlled by the computer 30, and the computer checks that the votes read from the barcode are correct.

Once the unambiguous votes have been recorded and verified by the Recording Subsystem, the computer stores the data and instructs the Tallying Subsystem 18 to deposit the ballot in a ballot storage box. Like the Verification subsystem 14, the Tallying Subsystem 18 transfers the ballot from one functional subsystem to its appropriate destination. In this case, the Tallying Subsystem transfers the ballot from the Recording Subsystem into a ballot storage box.

Upon acceptance of the votes as read, the central computer sums the votes to running aggregates or tallies and writes the tallies to a computer storage device 38 so that votes will not be lost in a power failure or other interruption. Alternatively, or in addition to the running aggregates, the individual sets of votes may be written to the computer storage device for subsequent tallying. While the computer storage device is typically a standard hard drive, it can be an alternative device such as a remote computer or redundant devices, one local and one distant.

In the final step, performed in the Receipt Subsystem 20, the same computer 30 is used to produce a printed copy of the votes cast for the voter's personal reference using the attached computer printer. While the actual tallying and receipt production are controlled by the computer, these functions are linked to the passing of the ballot to the ballot box by the Tallying subsystem. If the presentation of the accepted votes for verification is done on a printer, that printed list may be retained as the receipt.

FIG. 3 also shows the flow during recounting. In this process, the ballots pass through the Read Subsystem 12 and the Verification Subsystem 14. The Recording Subsystem does not print anything on the ballot, but does read the barcode to interpret the votes cast on the ballot. The barcode data are passed to the computer. Tallies are created within the computer as above and the ballots are transferred to the Ballot Storage Box by the Tallying Subsystem as above. Recording and Receipt devices may be used to recount ballots, or other devices capable of reading the barcodes could also be used.

The above division of functions into subsystems is presently preferred, although the invention can be implemented with the various functions combined or divided into subsystems using alternative plans.

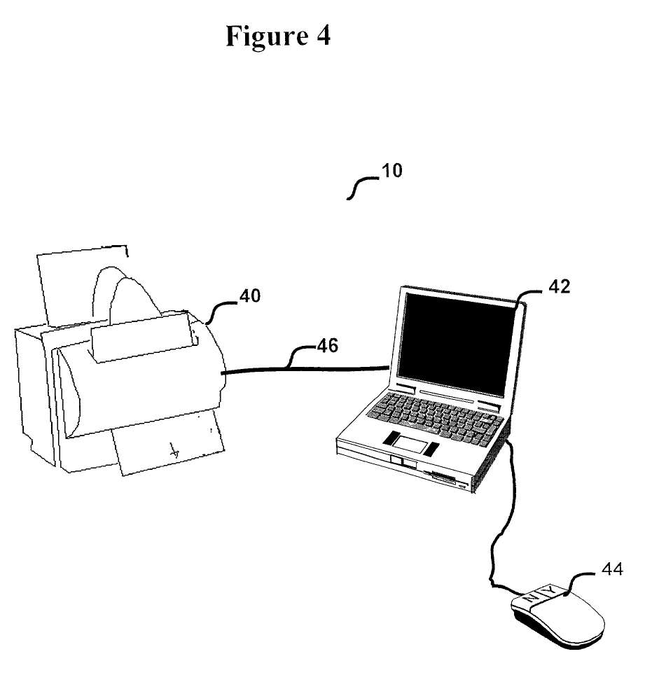

FIG. 4 shows a simple implementation of a Recording and receipt device 10 using three pieces of standard computer equipment and a metal ballot box. The first is a combined scanner/printer 40 , such as the Laserjet® Model 1100, made by Hewlett Packard (though it should be readily recognizable that the scanner and printer need not be combined). The second is a standard PC or laptop computer 42 with an external mouse 44 attached. In this implementation, the voter provides the functionality of the appropriate routing of the ballot through the various stages. Because of the significant interaction by the voter, instructions are displayed on the computer display. Initially the voter feeds the ballot into the scanner attached to the front of the scanner/printer 40. As the ballot passes through the scanner, the image of the ballot is passed to the computer through a bi-directional parallel cable 46 (though it should be readily recognizable that any manner of electronic data transmission could be used). The computer then interprets the marks on the ballot to obtain a set of apparent votes. These votes are then printed on a blank sheet of paper using the printer portion of the scanner/printer to show the voter the apparent votes. The voter examines the printed report to determine whether to choose to accept the votes as shown or to reject the votes as shown. To make indicating a choice easy, the computer mouse can be taped in a fixed location and the two buttons clearly labeled “Y” to accept or “N” to reject. If the voter presses the Reject button, he or she can then take the ballot and the printed list back to a voter station in order to make appropriate corrections. If the voter presses the “Accept” button, he or she then places the completed ballot in the alternate sheet input of the printer and the printer prints the barcode on the form. Finally, the voter passes the ballot back through the scanner which reads the barcode and indicates completion on the computer screen. Once completion is indicated, the system prints a final “verified” list of votes cast as a receipt. The voter takes the receipt, places the ballot in the ballot box and leaves with a printed receipt.

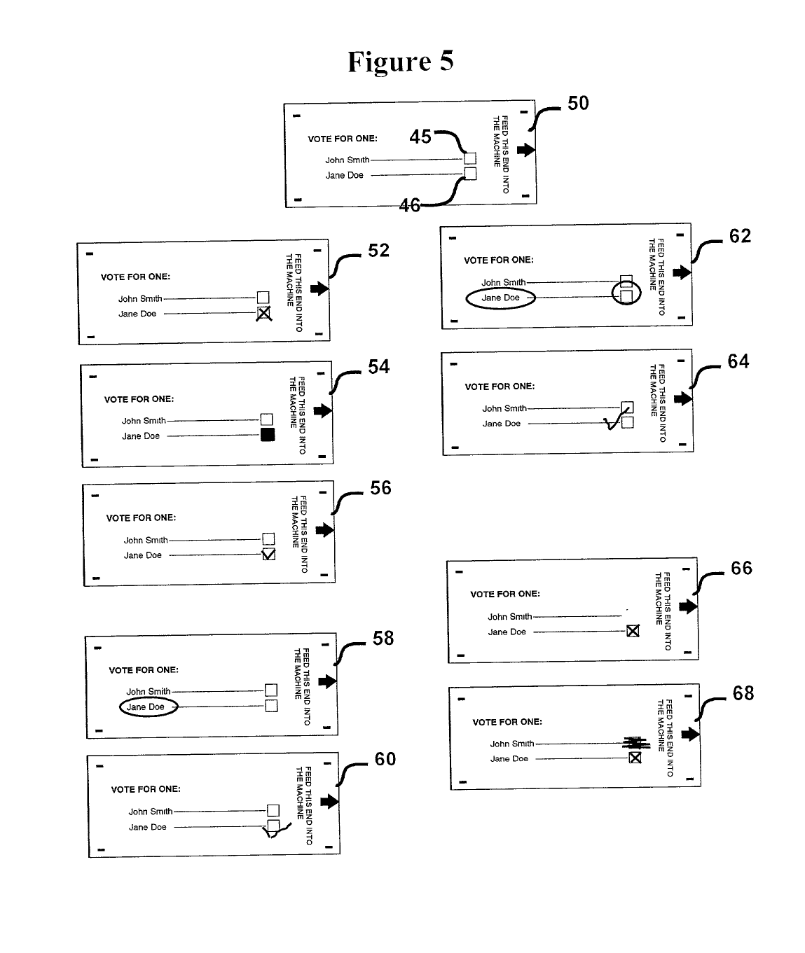

FIG. 5 shows a series of ballots suitable for optical processing as exemplars of ballots in which voting systems are likely to not properly record votes in accordance with the voter's wishes. The pre-printed ballot 50 has only one race and appropriate spaces to indicate preferences for either of two candidates by marking the square box for “John Smith” or the square box for Jane Doe”). The next three ballots 52, 54 and 56 show completed forms that should be unambiguously processed by any system.

The remaining ballots 58, 60, 62, 64, 66 and 68, however, all present cases where some persons or systems may fail to properly record the voter's intention. Ballots 58, 60, 62 and 64 show how voters can sometimes fail to properly mark ballots and how the marks can be outside the area examined based on the ballot instructions, in this case, the square. The only marks within either box are stray marks for a candidate for whom the voter probably did not intend to vote. Samples 66 and 68 show how erasures and scratch outs can be confused with intended marks. If the reading machine is instructed to take the “darker” or “heavier” mark, both votes will go to “John Smith”. If the reading machine is instructed to take the mark covering the large area, they will also go to “John Smith”. However, it is likely that the voter who completed ballot 66 intended to erase the first and vote for “Jane Doe” while the voter who completed ballot 68 intended to cross out the vote for “John Smith” and vote for “Jane Doe” so that both of the voters had intention to vote for “Jane Doe”. In fact, for all of the filled in ballots (52 through 68), the voter probably intended to vote for Jane Doe. However, it is likely that most systems would assign only the first three ballot votes 52, 54 and 56 to Jane Doe, with two abstentions 58 and 60, and with four votes for John Smith 62 through 68). The resulting tally, Smith-4, Doe-3, and abstentions or uncounted 2 differs dramatically from the intended tally of Doe-8 and Smith-0.

While the preferred embodiment is based on the use of marked paper ballots, aspects of this invention may be used with punch-card, electronic, and other voting systems.

While, in the preferred implementation of this invention, the unambiguous recording of the votes on the ballots is based on the votes as verified by the voter, the recording of the votes as processed by the vote counting device can be beneficial even when the voter does not verify the set of votes. Since there are always some ballots which are borderline votes, and since any equipment can malfunction, the recording of votes as counted can help identify mis-counted ballots during a recount process or investigation. Such a procedure can also be used to validate the vote counting process and other functions.

For locales that use mechanical “punched” ballots, the same systems can be used with the addition of a recording and receipt device at the polling place. After the ballots have been “punched,” the voter or election official will place the punched ballot in a recording and receipt device which will “read” the pattern of holes using an inexpensive card reading system. Then the same procedures will be used as with a marked paper ballot including showing the voter the set of votes as read, allowing the voter to accept or reject the votes, and then giving the voter a receipt showing all votes processed. This implementation of the invention will allow consistency in voting procedures, thereby avoiding the expense of educational programs to introduce voters to new systems and the inevitable confusion and delays associated with the implementation of new types of voting systems. In addition, this implementation requires only a relatively few recording and receipt devices compared with the total number of punch card devices. This will be less expensive than providing a new, sophisticated voting device to replace each punch card devices, although polling-placed scanning is generally more expensive than central-based scanning.

The invention can be used with electronic voting systems such as that shown by U.S. Pat. No. 6,081,793 to Challener, et al., which is incorporated herein by reference. After the voter has recorded all of his or her choices, the system should present a single representation of the choices. Ideally, this representation should be in a different modality, or at least a different style than the presentation used to record the votes. This representation only show the choices selected to the exclusion of the choices not selected. Based on that representation, the voter could opt to have the votes tallied, or opt to go back and change one or more selections. When the voter chooses to have the votes tallied, the system should immediately record the votes. In order to implement the safeguards in this invention, the system should also produce an independent record of the set of votes such as on paper, or by using a barcode or similar unambiguous recording system. If the system is on-line, the independent record should be recorded at a separate physical location so that the tallies can be reconstructed even with a catastrophic destruction of the main Recording and Receipt system. At the same time, the voter should receive a receipt showing the votes cast.

While the voting system includes immediate tallying of each voter's votes once the voter vets the set, the votes can be held for subsequent tallying.

Although the invention has been described and illustrated with respect to the exemplary embodiments thereof, it should be understood by those skilled in the art that the foregoing and various other changes, omissions and additions may be made therein and thereto, without parting from the spirit and scope of the present invention.

I claim:

1. A method of recording a set of votes cast by a voter on a paper ballot comprising the steps of:
(a) creating an electronic representation of an apparent set of votes cast by the voter, the apparent set of votes being an interpretation of voter intent based on the voter's interaction with the paper ballot;
(b) disclosing to the voter the apparent set of votes cast;
(c) receiving from the voter an indication whether to accept or reject the set of votes in the disclosure;
(d) providing the voter opportunity to replace or correct the apparent set of votes as cast until the voter accepts the set of votes in the disclosure; and
(e) counting the votes when the set is accepted by the voter.

2. The method in claim 1 comprising the further step of:
(a) creating an electronic record of the accepted votes for use in subsequent recounts.

3. The method in claim 2 wherein the electronic record of the accepted votes is recorded as a machine-readable barcode.

4. The method in claim 2 comprising the further steps of:
(a) reading the electronic record of the accepted votes;
(b) comparing the votes based on the reading of the electronic record of the accepted votes with the counted accepted votes; and
(c) providing appropriate procedures correct any disparity between the recorded votes and the counted votes.

5. The method in claim 1 comprising the further step of:
(a) creating a printed receipt for the voter showing the accepted votes.

6. The method in claim 1 wherein votes are cast by making marks on a paper ballot.

7. The method in claim 6 wherein the electronic representation of the apparent set of votes cast by the voter is obtained through a digitized image of the ballot captured by a scanning device.

8. The method in claim 1 wherein the votes are cast by using a device to punch holes in a paper ballot.

9. A method to accurately reconstruct a count of votes made by a plurality of voters after an initial counting, comprising the steps of:
(a) creating an electronic record of the votes cast by each voter;
(b) reading the electronic record of each voter;
(c) comparing the votes read from the electronic record of each voter with the votes that are going to be included in the initial counting;
(d) providing a procedure to correct any disparity between the votes from the electronic record and the votes to be included in the initial counting; and
(e) reconstructing the count of votes by tallying the electronic records.

10. A method to accurately reconstruct a count of votes made by a plurality of voters using paper ballots after an initial counting of the votes from the ballots, comprising the steps of:
(a) creating an electronic record of the votes cast on each ballot prior to the initial counting;
(b) reading the electronic record of each ballot;
(c) comparing the votes read from the electronic record of each ballot with the votes from the ballot that are going to be included in the initial counting;
(d) providing appropriate procedures to correct any disparity between the votes from the electronic record and the votes to be included in the initial counting; and
(e) reconstructing the count of votes by tallying the electronic records.

11. The method in claim 10 wherein the electronic record is recorded on each ballot by a printed barcode.

12. An apparatus for recording a set of votes cast by a voter on a paper ballot comprising:
(a) means for creating an electronic representation of the apparent set of votes cast by the voter, the apparent set of votes being an interpretation of voter intent based on the voter's interaction with the paper ballot;
(b) means for disclosing to the voter the apparent set of votes cast, means for receiving from the voter an indication whether to accept or reject the apparent set of votes in the disclosure; means for providing the voter opportunity to replace or correct the apparent set of votes as cast until the voter accepts the vote as indicated in the disclosure; and
(c) means for counting the votes when the set is accepted by the voter.

13. The apparatus in claim 12 further comprising:
(a) means for creating an electronic record of the accepted votes for use in subsequent recounts.

14. The apparatus in claim 13 further comprising:
(a) a device capable of printing the electronic record in the form of a barcode.

15. The apparatus in claim 13 further comprising:
(a) means for reading the electronic record of the accepted votes; and
(b) means for comparing the votes case based on the reading of the electronic record of the accepted votes with the accepted votes.

16. The apparatus in claim 12 further comprising:
(a) means for printing a receipt report showing the accepted votes.

17. The apparatus in claim 12 further comprising:
(a) means for reading marks made by the voter on the paper ballot to indicate the votes cast.

18. The apparatus in claim 17 wherein the means for reading marks made by the voter on the paper reads a digitized image of the ballot.

19. The apparatus in claim 12 further comprising::
(a) means for reading holes caused to be made in the paper ballot by action of the voter in order to indicate the votes cast.

20. An apparatus to accurately reconstruct a count of votes made by a plurality of voters after an initial counting, the apparatus comprising:
(a) means for creating an electronic record of the votes cast by each voter;
(b) means for reading the electronic record of the votes cast by each voter, means for comparing the votes read from the electronic record of each voter with the votes that are going to be included in the initial counting;
(c) means for correcting any disparity between the votes read from the electronic record of each voter and the votes that are going to be included in the initial counting; and reconstructing the count of votes by tallying the electronic records.

21. An apparatus to accurately reconstruct a count of votes made by a plurality of voters using paper ballots after an initial counting of the votes from the ballots, the apparatus comprising:
(a) means for creating an electronic record of the votes cast on each ballot prior to the initial counting;
(b) means for reading the electronic record of each ballot; means for comparing the votes read from the electronic record of each ballot with the votes from the ballot that are going to be included in the initial counting;
(c) means for correcting any disparity between the votes from the electronic record and the votes to be included in the initial counting; and
(d) means for reconstructing the count of votes by tallying the electronic records.
